(19) United States
(12) Patent Application Publication
(10) Pub. No.: US 2011/0180279 A1
(43) Pub. Date: Jul. 28, 2011

(54) DEVICE AND METHOD OF PROTECTING A FIRE EXTINGUISHER

(75) Inventor: Carlos A. FELLER, Kibbutz Lehavot HaBashan (IL)

(73) Assignee: Lehavot Fire Protection Ltd., Kibbutz Lehavot HaBashan (IL)

(21) Appl. No.: 12/692,614

(22) Filed: Jan. 24, 2010

(51) Int. Cl. A62C 99/00

(52) U.S. Cl. 169/51

(57) ABSTRACT

A fire extinguisher wrapper for protecting a fire extinguisher having a separable ballistic resistance member sized to cover tightly at least a peripheral surface of a pressure vessel of a fire extinguisher.

### FIELD AND BACKGROUND OF THE INVENTION

The present invention, in some embodiments thereof, relates to fire extinguishers and, more particularly, but not exclusively, to device and method of enhancing the protection people in proximity to fire extinguishers.

Recent experience in warfare conflicts has identified the importance of fire suppression to protect the passengers of armored combat vehicles and tactical wheeled vehicles, for example tanks and/or other armored fighting vehicles (AFVs) and/or military sport utility vehicle (SUV). Automatic and/or manual fire extinguishing systems (AFESs) are installed in the passenger compartment of most military vehicles which are used by Western armed forces.

Fire suppression devices usually include one or more pressure vessels containing an agent which can be discharged to extinguish a fire in a high pressure. For example, pressure vessels in which agents are pressurized to between about 12 bar at standard temperature pressure (STP) and about 42 Bar at STP and pressure vessels that hold nitrogen gas in higher pressure. As the pressure vessels contain fire extinguishing agents in high pressure, they may explode in case of a hit of an armor piercing bullet, a splinter, or the like. Some military standards require that pressure vessels which held in the passenger compartment are blast resisted. It requires that pressure vessel be designed to mitigate the hazard from flying pressure vessel fragments in the case of an explosive event, for example as an outcome of a direct armor piercing bullet hit. The intent of these criteria is to reduce or eliminate the potential hazards to people, recognizing that a pressure vessel in not bullet proof. These criteria require that pressure vessels meet performance levels that correspond to specific levels of protection.

Chinese patent Publication number CN2817904 (Y) describes a bottled fire extinguisher. The bottled fire extinguisher comprises a bottle body of which the bottle mouth is provided with threads, and a bottom end cover of the bottle body is welded on the bottle body, or is fixed on the bottle body in other modes. The bottom end cover of the bottle body and the bottle body are an integrative structure, and an air leakage structure for preventing the bottle body form exploding is formed on the side surface of the bottle body; the air leakage structure is a section of a bottle wall formed at the middle part of the bottle body, and the bottle wall is thin corresponding to other parts of the bottle body. The bottled fire extinguisher is designed to have long service life and small risk when explosion is generated under particular conditions.

### SUMMARY OF THE INVENTION

According to some embodiments of the present invention there is provided a fire extinguisher wrapper for protecting a fire extinguisher having a separable ballistic resistance member sized to cover tightly at least a peripheral surface of a pressure vessel of a fire extinguisher.

Optionally, the separable ballistic resistance member is made of at least one layer of fibers.

Optionally, the separable ballistic resistance member covers only the peripheral surface.

Optionally, the separable ballistic resistance member is configured to be manually removed from the fire extinguisher and manually placed to cover tightly another fire extinguisher.

More optionally, the at least one layer of fibers comprises fibers selected from a group consisting of Dyneema, Gold Flex and Spectra, Twaron, Dragon Skin, and Zylon.

More optionally, the at least one layer of fibers comprises Ultra high molecular weight polyethylene (UHMWPE) fibers.

Optionally, the separable ballistic resistance member comprises a plurality of plates.

More optionally, the plurality of plates are selected from a group consisting of ceramic plates, steel plates, titanium plates, aluminum plates, and carbon composite plates.

Optionally, the separable ballistic resistance member comprises foldable plate adapted to be cylindrical in shape.

Optionally, the separable ballistic resistance member further covers at least one of the top and the bottom of the pressure vessel.

Optionally, the fire extinguisher wrapper further comprises fastening means for firmly attach the separable ballistic resistance member around the pressure vessel of the fire extinguisher.

More optionally, the fastening means configured for detachably attach the separable ballistic resistance member around the pressure vessel the fire extinguisher so as to allow manually detaching the separable ballistic resistance member.

Optionally, the fire extinguisher having the separable ballistic resistance member is not fragmented when hit by a tumbling projectile at a velocity of at least 792 meter per second.

More optionally, the velocity of at least 900 meters per second.

Optionally, the fire extinguisher having a pressure of less than 137 Bar at STP.

Optionally, the fire extinguisher having a pressure of 137 Bar at STP.

According to some embodiments of the present invention there is provided a method of adding a protection layer to a fire extinguisher. The method comprises providing a separable ballistic resistance member sized to cover tightly at least a peripheral surface of a pressure vessel of a fire extinguisher and firmly attach the separable ballistic resistance member to at least the peripheral surface using the separable ballistic resistance member. The separable ballistic resistance member is configured for being manually detached from the pressure vessel.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of an automatic or a handheld fire extinguisher covered by a fire extinguisher wrapper, according to some embodiments of the present invention;

FIG. 2 is a schematic illustration of a fire extinguisher wrapper which is adhered to the peripheral surface of the pressure vessel, according to some embodiments of the present invention;

FIG. 3 is a schematic illustration of a automatic or handheld fire extinguisher covered by a fire extinguisher wrapper which is laced therearound, according to some embodiments of the present invention; and

FIG. 4 is a flowchart of a method of enhancing the fragmentation resistance of the pressure vessel, according to some embodiments of the present invention.

### DESCRIPTION OF EMBODIMENTS OF THE INVENTION

The present invention, in some embodiments thereof, relates to fire extinguishers and, more particularly, but not exclusively, to device and method of enhancing the protection people in proximity to fire extinguishers.

According to some embodiments of the present invention, there is provided a projectile absorbing and/or fragmentation prevention cover for absorbing the impact from firearm-fired projectiles and shrapnel from explosions and/or protecting a fire extinguisher from fragmenting in case an impact of a tumbling projectile, such as a bullet. The cover has a separable ballistic resistance member which is sized to cover tightly at least a peripheral surface of a pressure vessel of a fire extinguisher. Optionally, the cover includes one or more fastening means for firmly attach the separable ballistic resistance member to the pressure vessel. Optionally, the ballistic resistance member is made of one or more layers fibers, optionally woven, for example aramid and/or Ultra high molecular weight polyethylene (UHMWPE) fibers. Optionally, the ballistic resistance member includes one or more ballistic resistance plates, such as ceramic plates. Optionally, cover may be attached to fire extinguishers which are ready for use, for example vehicle fire extinguishers.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

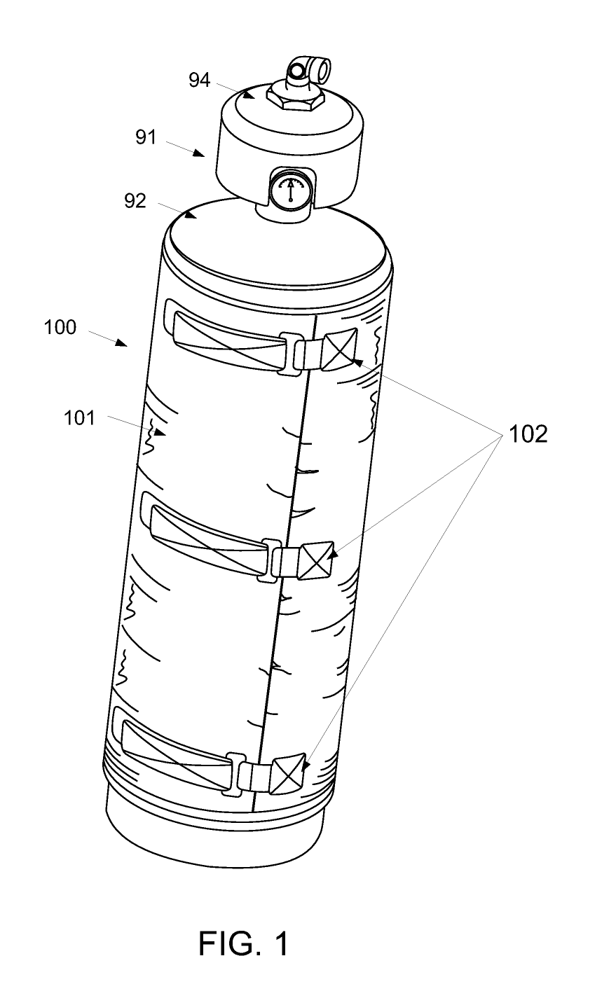

Reference is now made to FIG. 1, which is a schematic illustration of a automatic or automatic or handheld fire extinguisher 91 covered by a projectile absorbing and/or fragmentation prevention fire extinguisher wrapper 100, according to some embodiments of the present invention. The fire extinguisher wrapper 100 includes a ballistic resistance member 101, such as a piece of ballistic resistance material, optionally rectangular, which is sized to cover tightly at least a peripheral surface of a pressure vessel 92 of the fire extinguisher 91. Optionally, the ballistic resistance member 101 is sized to cover tightly also the top and/or the bottom of the pressure vessel 92.

Optionally, the ballistic resistance member 101 is separated from the fire extinguisher 91. As used herein, a separable ballistic resistance member means a ballistic resistance member designed for being placed to cover at least the peripheral surface of a pressure vessel which is ready for use. Optionally, the ballistic resistance member 101 is designed for being detached from and reattached to the fire extinguisher 91.

Optionally, the ballistic resistance member 101 is designed for covering the pressure vessel 92 of an automatically activated fire extinguishing devices and systems. Such pressure vessel 92 includes fire extinguishing compound which are disperse automatically into a space, room or area.

The ballistic resistance member 101 is optionally firmly attached to the pressure vessel 92 by fastening means 102. The fastening means 102 in FIG. 1 are interlocking strips, for example interlocking nylon strips, such as Velcro™ strips.

The fire extinguisher 91 may be any automatic or handheld fire extinguisher having a hand-held cylindrical pressure vessel 92 containing an agent which can be discharged to extinguish a fire, for example a gaseous agent that inhibits the chemical reaction of the fire, such as halocarbon agents. The agent may include a dry chemical, such as Ammonium phosphate, Sodium bicarbonate, Potassium bicarbonate, potassium bicarbonate and urea complex, potassium chloride, foam-compatible, and MET-L-KYL, foams such as aqueous film forming foam (AFFF), Alcohol-resistant aqueous film forming foams (AR-AFFF), film forming fluoroprotein (FFFP) and compressed air foam, and wet chemicals, such as potassium acetate, carbonate, and/or citrate. The fire extinguisher 91 further includes a discharging valve 94 supported on the cylindrical pressure vessel 92. The fire extinguisher 91 may be provided in various sizes, for example 3 liter capacity, 6 liter capacity, 9 liter capacity, and 12 liter capacity.

The ballistic resistance member 101 is made to absorb the impact from firearm-fired projectiles and shrapnel from explosions and/or to resist a fragmentation of the pressure vessel 92 in case an impact of such tumbling projectiles, such as bullets, for example 0.50 caliber M-2, armor piercing bullets, missiles, and/or shrapnel. Optionally, the resistance is in case of an impact of tumbling projectiles having a velocity of about 792 meters per second or less, and/or about 1200 meters per second or less. Optionally, the resistance is in case of an impact of tumbling projectiles when the pressure vessel has been charged to a pressure of about 137 Bar at STP or less, for example about 124 Bar at STP.

As shown in the exemplary result provided below, the ballistic resistance member 101 prevents the fragmentation of the pressure vessel 92 in case an impact of a tumbling projectile in various directions, for example when the pressure vessel 92 is placed with a longitudinal axis perpendicular to the line of fire of the tumbling projectile, with the longitudinal axis in 45 degrees (0.735 rad) to the line of fire of the tumbling projectile and/or with the longitudinal axis parallel to the line of fire of the tumbling projectile. The prevention assures that fire extinguishers, such as 91, are not fragmented when hit by a tumbling projectile, optionally as required in military standards, such as MIL-DTL-79065II, and/or other standards, such as D.O.T-3AA, which are incorporated herein by reference. In such an embodiment, the shell of the pressure vessel 92 remains in one piece after being hit by a tumbling projectile.

Optionally, the fire extinguisher wrapper 100 is detachably attached to the pressure vessel 92. In such a manner, the fire extinguisher wrapper 100 may be manually attached to fire extinguishers which have not been manufactured as fragmentation resisted fire extinguishers and/or moved from one fire extinguisher to another. In such a manner, relatively cheap and/or light fire extinguishers, which are not designated to pursuant safety standards, such as MIL-DTL-79065II and/or D.O.T-3AA, may be covered with the fire extinguisher wrapper 100 to achieve a fragmentation resistant as required in these standards. In addition, the ability to detach and reattach the fire extinguisher wrapper 100 facilitates the maintenance of the covered pressure vessel 92 and allows reusing the fire extinguisher wrapper 100 without subjecting it to the manufacturing processes.

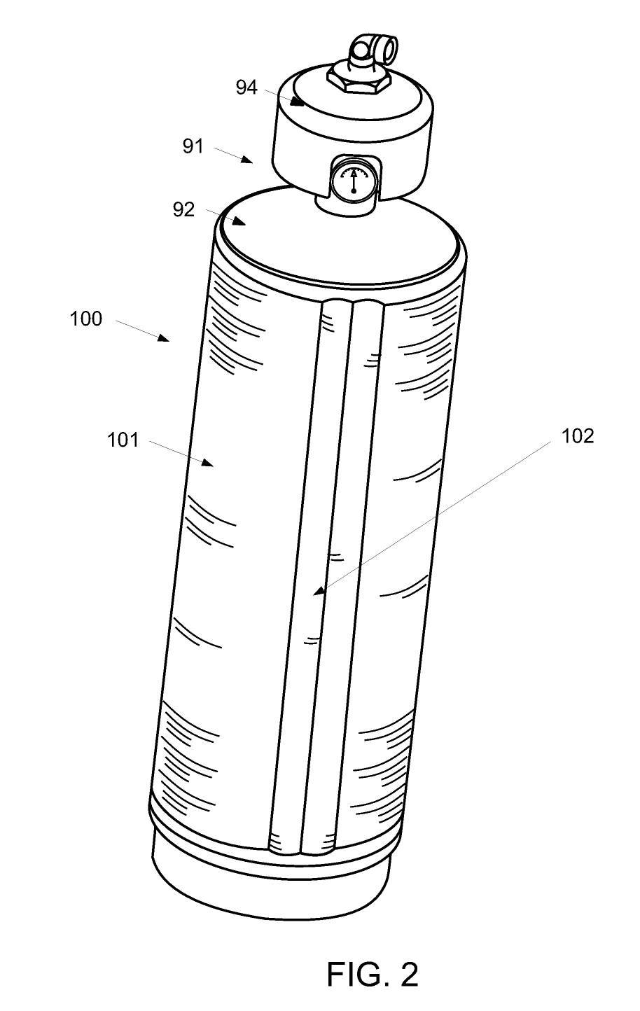

Optionally, the fire extinguisher wrapper 100 is attached to the pressure vessel 92 during the manufacturing process. In such an embodiment, the fire extinguisher wrapper 100 may be adhered and/or welded to peripheral surface of the pressure vessel 92 and/or undetachably stitched so as to attach firmly the ballistic resistance member 101 to the pressure vessel 92. For example, FIG. 2 depicts a fire extinguisher wrapper adhered to the peripheral surface of the pressure vessel 92. The fastening means are strips adhered to one another and/or to the pressure vessel 92.

Optionally, the ballistic resistance member 101 is sized to cover substantially the peripheral surface of a cylindrical vessel, for example as shown at FIG. 1. The bottom and the top of the pressure vessel 92 remain uncovered. In such manner, the fire extinguisher wrapper 100 may be manually attached to the automatic or handheld fire extinguisher 91 in a relatively simple and fast process.

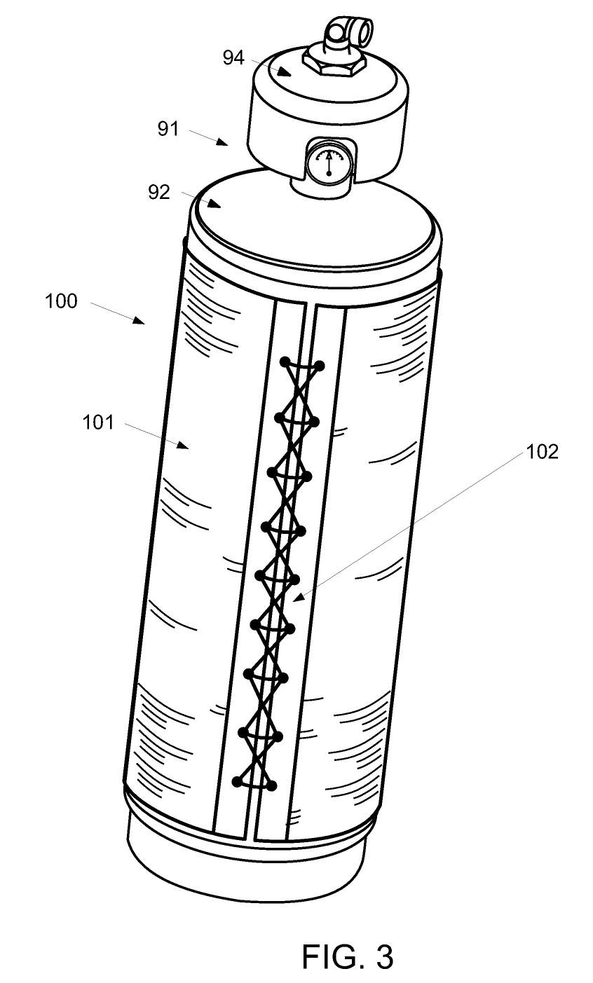

Optionally, the fastening means 102 are lace apertures in the ballistic resistance member 101. These apertures allow firmly attaching it to the pressure vessel 92 by tying one or more laces or wires therethrough, for example as shown in FIG. 3.

According to some embodiments of the present invention, the ballistic resistance member 101 is made of one or more layers fibers, optionally woven. The fibers may be aramid fibers, such as GoldFlex™ of Honeywell™, Twaron bobbin Twaron® and/or Ultra high molecular weight polyethylene (UHMWPE) fibers. The fibers may be woven as in a commonly used ballistic vest. Optionally, one or more of the layers of polyethylene fibers, such as DSM™ Dyneema™ and/or thermoset liquid crystalline polyoxazole fibers such as Zylon™. Optionally, the ballistic resistance member 101 includes one or more flexible layers of scales attached to a backing material, for example Dragon Skin of Pinnacle Armor.

According to some embodiments of the present invention, the ballistic resistance member 101 includes one or more plates, such as ceramic plates, steel plates, titanium plates, aluminum plates, and carbon composite plates. Optionally, the plates are sized and shaped to fit the surface of the pressure vessel 92. For example, the plate may be curved to allow tightly cover of a cylindrical surface, such as a surface of an automatic or a handheld pressure vessel 92, such as shown in FIGS. 1-2. The plates may be adhered to the ballistic resistance member 101, placed in pockets of the pressure vessel 92, and/or sewed inside the pressure vessel 92.

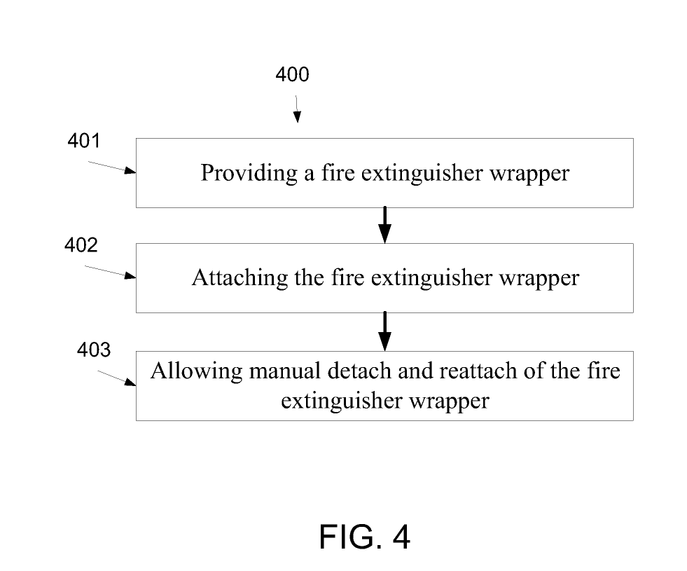

Reference is now made to FIG. 4, which is a flowchart of a method of enhancing the fragmentation resistance of the pressure vessel 92, according to some embodiments of the present invention.

First, as shown at 401, a fire extinguisher wrapper sized and shaped to cover at least the peripheral surface of a pressure vessel of a fire extinguisher is provided. The fire extinguisher may be any fire extinguisher, for example having a cylinder having a diameter of more than 2.5 inches.

Then, as shown at 402, the ballistic resistance member is firmly attached to the peripheral surface of the pressure vessel, for example using fastening means.

Now, as shown at 403, the fire extinguisher wrapper may be manually detached from the pressure vessel, for example for maintenance or pressure vessel replacement. The reattachment by using the fastening means 102.

It is expected that during the life of a patent maturing from this application many relevant system and method will be developed and the scope of the term a pressure vessel and a ballistic resistance member is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A fire extinguisher wrapper for protecting a fire extinguisher having a separable ballistic resistance member sized to cover tightly at least a peripheral surface of a pressure vessel of a fire extinguisher.

2. The fire extinguisher wrapper of claim 1, wherein said separable ballistic resistance member is made of at least one layer of fibers.

3. The fire extinguisher wrapper of claim 1, wherein said separable ballistic resistance member covers only said peripheral surface.

4. The fire extinguisher wrapper of claim 1, wherein said separable ballistic resistance member is configured to be manually removed from the fire extinguisher and manually placed to cover tightly another fire extinguisher.

5. The fire extinguisher wrapper of claim 2, wherein said at least one layer of fibers comprises fibers selected from a group consisting of Dyneema, Gold Flex and Spectra, Twaron, Dragon Skin, and Zylon.

6. The fire extinguisher wrapper of claim 2, wherein said at least one layer of fibers comprises Ultra high molecular weight polyethylene (UHMWPE) fibers.

7. The fire extinguisher wrapper of claim 1, wherein said separable ballistic resistance member comprises a plurality of plates.

8. The fire extinguisher wrapper of claim 7, wherein said plurality of plates are selected from a group consisting of ceramic plates, steel plates, titanium plates, aluminum plates, and carbon composite plates.

9. The fire extinguisher wrapper of claim 1, wherein said separable ballistic resistance member comprises foldable plate adapted to be cylindrical in shape.

10. The fire extinguisher wrapper of claim 1, wherein said separable ballistic resistance member further covers at least one of the top and the bottom of said pressure vessel.

11. The fire extinguisher wrapper of claim 1, further comprising fastening means for firmly attach said separable ballistic resistance member around the pressure vessel of said fire extinguisher.

12. The fire extinguisher wrapper of claim 11, wherein said fastening means configured for detachably attach said separable ballistic resistance member around the pressure vessel said fire extinguisher so as to allow manually detaching said separable ballistic resistance member.

13. The fire extinguisher wrapper of claim 1, wherein said fire extinguisher having said separable ballistic resistance member is not fragmented when hit by a tumbling projectile at a velocity of at least 792 meter per second.

14. The fire extinguisher wrapper of claim 13, wherein said velocity of at least 900 meters per second.

15. The fire extinguisher wrapper of claim 1, wherein said fire extinguisher having a pressure of less than 137 Bar at STP.

16. The fire extinguisher wrapper of claim 1, wherein said fire extinguisher having a pressure of 137 Bar at STP.

17. A method of adding a protection layer to a fire extinguisher, comprising:
providing a separable ballistic resistance member sized to cover tightly at least a peripheral surface of a pressure vessel of a fire extinguisher; and
firmly attach said separable ballistic resistance member to at least said peripheral surface using said separable ballistic resistance member;
wherein said separable ballistic resistance member is configured for being manually detached from said pressure vessel.
